(19) United States
(12) Patent Application Publication
(10) Pub. No.: US 2013/0236283 A1
(43) Pub. Date: Sep. 12, 2013

(54) METHOD AND APPARATUS FOR WAFER ALIGNMENT

(71) Applicant: SAMSUNG ELECTRONICS CO., LTD., Suwon-si (KR)

(72) Inventors: Seung Woo Choi, Gunpo (KR); Gyeong Seon Park, Seoul (KR)

(73) Assignee: SAMSUNG ELECTRONICS CO., LTD., Suwon-si (KR)

(21) Appl. No.: 13/751,572

(22) Filed: Jan. 28, 2013

(30) Foreign Application Priority Data
Mar. 7, 2012 (KR) 10-2012-0023263

(51) Int. Cl. F16M 13/00

(52) U.S. Cl. CPC F16M 13/00
USPC 414/754; 414/816

(57) ABSTRACT

A wafer aligning apparatus includes first and second wafer holders supporting first and second wafers, respectively, a holder moving unit configured to move at least one of the first and second wafer holders such that the first and second wafers are pre-aligned and face each other, one or more observing units arranged in a horizontal direction with respect to the pre-aligned first and second wafers and configured to observe edge portions of the first and second wafers in a state in which the first and second wafers are pre-aligned with each other by the holder moving unit and a controlling unit configured to control the holder moving unit to realign the first and second wafers when the edge portions of the first and second wafers are outside of a desired alignment state based on information observed by the one or more observing units.

### CROSS-REFERENCE TO RELATED APPLICATIONS

This application claims priority to Korean Patent Application No. 10-2012-0023263 filed on Mar. 7, 2012, the disclosure of which is hereby incorporated by reference herein in its entirety.

### TECHNICAL FIELD

The present disclosure relates to a method and apparatus for wafer alignment.

### DISCUSSION OF THE RELATED ART

During the manufacturing of a semiconductor, the alignment of wafers should be performed.

For example, a mechanical alignment method is widely used. In the mechanical alignment method, three exterior points of two wafers to be aligned are appropriately determined according to shapes thereof, and the wafers are moved to be aligned with each other via physical contact on the exterior points. However, when wafers are aligned with each other by using this method, there may be a limit in increasing alignment accuracy due to issues of processes and equipment, and difficulties may arise with wafer alignment due to different wafer shapes.

As another method, an alignment key is formed on two wafers to be aligned and the wafers are aligned with each other by using the alignment key. However, this method may require an additional process of forming an alignment key on two wafers. Further, as equipment using an alignment key is relatively expensive, it may be difficult to realize mass production through the use thereof.

### SUMMARY OF THE INVENTION

Exemplary embodiments of the present invention provide a method and apparatus for wafer alignment, able to increase alignment accuracy via simplified processes.

According to an exemplary embodiment of the present invention, there is provided a wafer aligning apparatus including: first and second wafer holders supporting first and second wafers, respectively, a holder moving unit configured to move at least one of the first and second wafer holders such that the first and second wafers are pre-aligned and face each other, one or more observing units arranged in a horizontal direction with respect to the pre-aligned first and second wafers and configured to observe edge portions of the first and second wafers in a state in which the first and second wafers are pre-aligned with each other by the holder moving unit and a controlling unit configured to control the holder moving unit to realign the first and second wafers when the edge portions of the first and second wafers are outside of a desired alignment state based on information observed by the one or more observing units.

The one or more observing units may include microscopes.

The one or more observing units may include a plurality of observing units, and the plurality of observing units are configured to observe the edge portions in different positions.

The observing units may be provided to be symmetrical with respect to the pre-aligned first and second wafers.

The one or more observing units may be configured to observe observation points on tangents between the one or more observing units and outlines of the pre-aligned first and second wafers.

The holder moving unit controlled by the controlling unit may be configured to move the first and second wafer holders in an XYθ direction.

The first and second wafers may have the same shape and area, and the desired alignment state may be a state in which cross sections of the edge portions of the upper and lower wafers are positioned on a single straight line.

The first and second wafers may be different in terms of at least one of shape and area thereof, and the desired alignment state may be a state in which cross sections of the edge portions of the upper and lower wafers are equally deviated at the edge portions of the upper and lower wafers observed via the plurality of observing units.

According to an exemplary embodiment of the present invention, there is provided a method of wafer alignment, including: arranging first and second wafers on first and second wafer holders, pre-aligning the first and second wafers with each other to face each other by moving at least one of the first and second wafer holders, observing edge portions of the first and second wafers by using one or more observing units arranged in a horizontal direction with respect to the pre-aligned first and second wafers and realigning the first and second wafers with each other when the edge portions of the first and second wafers observed by the one or more observing units are outside of a desired alignment state.

The one or more observing units may include microscopes.

The one or more observing units may include a plurality of observing units, and the plurality of observing units may be configured to observe the edge portions in different positions.

The one or more observing units may be provided to be symmetrical with respect to the pre-aligned first and second wafers.

The one or more observing units may be configured to observe observation points on tangents between the one or more observing units and outlines of the pre-aligned first and second wafers.

The realigning of the first and second wafers may include moving the first and second wafer holders in an XYθ direction.

The first and second wafers may have the same shape and area, and the desired alignment state may be a state in which cross sections of the edge portions of the upper and lower wafers are positioned on a single straight line.

The first and second wafers may be different in teens of at least one of shape and area thereof, and the desired alignment state may be a state in which cross sections of the edge portions of the upper and lower wafers are equally deviated at the edge portions of the upper and lower wafers observed via the plurality of observing units.

In an exemplary embodiment of the present invention, a wafer aligning apparatus is provided. The wafer aligning apparatus includes an upper wafer holder and a lower wafer holder configured to support an upper wafer and a lower wafer, respectively, by a force of vacuum suction, a holder moving unit configured to move at least one of the upper wafer holder and the lower wafer holder in at least one of an upward and downward direction, respectively such that the upper and lower wafers are pre-aligned and face each other, and a plurality of microscopes accommodated in a corresponding one of a plurality of microscope supports and movable therein. The microscopes are arranged in a horizontal direction with respect to the pre-aligned upper and lower wafers so as to be symmetrical with respect to the upper and lower wafers and configured to observe: edge portions of the upper and lower wafers in a state in which the upper and lower wafers are pre-aligned with each other by the holder moving unit.

The wafer aligning apparatus further includes a controlling unit operatively connected to the microscopes and configured to receive and read observation data from the microscopes and to control the holding moving unit to move at least one of the upper wafer holder and the lower wafer holder in an XYθ direction based upon the transmitted observation data to thereby realign the upper and lower wafers.

### BRIEF DESCRIPTION OF THE DRAWINGS

Exemplary embodiments of the present invention can be understood in further detail from the following detailed description taken in conjunction with the accompanying drawings, in which:

FIG. 1 is a schematic diagram of a wafer aligning apparatus according to an embodiment of the present invention;

FIG. 2 is a plan view showing a method of observing upper and lower wafers, which are pre-aligned with each other, via microscopes of the wafer aligning apparatus of FIG. 1;

FIG. 3 shows edge portions of the upper and lower wafers, which are observed by the microscopes of the wafer aligning apparatus of FIG. 1; and

FIG. 4 shows edge portions of upper and lower wafers, which are observed by microscopes of a wafer aligning apparatus according to an embodiment of the present invention, when the upper and lower wafers are different in terms of shape or area thereof.

### DETAILED DESCRIPTION OF EXEMPLARY EMBODIMENTS

Embodiments of the present invention will now be described in detail with reference to the accompanying drawings.

In the drawings, the shapes and sizes of elements may be exaggerated for clarity and the same reference numerals will be used throughout to designate the same or like elements.

As used herein, the singular forms, “a”, “an”, and “the” are intended to include plural forms as well, unless the context clearly indicates otherwise.

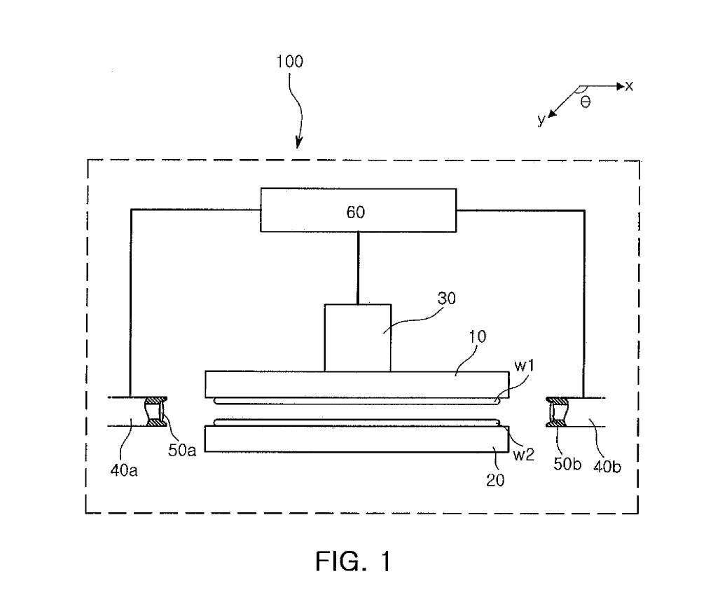

FIG. 1 is a schematic diagram of a wafer aligning apparatus 100 according to an embodiment of the present invention.

Referring to FIG. 1, the wafer aligning apparatus 100 according to the present embodiment includes, for example, an upper wafer holder 10 and a lower wafer holder 20, which respectively support upper and lower wafers W1 and W2, a holder moving unit 30, one or more observing units including a first microscope support 40a, a second microscope support 40b and a microscope set including a first microscope 50a and a second microscope 50b, and a controlling unit 60.

The lower wafer W2 is positioned on the lower wafer holder 20 and the upper wafer W1 is held by the upper wafer holder 10 by, for example, the force of vacuum suction. The upper wafer holder 10 may be connected to the holder moving unit 30 so as to be moved in, for example, an XYθ direction according to an operation of the holder moving unit 30.

The first microscope support 40a and the second microscope support 40b may accommodate the first microscope 50a and the second microscope 50b and move the first microscope 50a and the second microscope 50b, respectively. The first microscope 50a and the second microscope 50b are arranged in, for example, a horizontal direction with respect to the pre-aligned upper and lower wafers W1 and W2 so as to be symmetrical with respect to the upper and lower wafers W1 and W2 and are used to observe alignment states of the upper and lower wafers W1 and W2 in the wafer aligning apparatus 100.

For example, throughout this specification, pre-alignment may refer to a state in which wafers are previously aligned with each other by using a common wafer moving method to prepare subsequent processes such as adherence or deposition and may include a state in which two wafers are spaced apart from each other in a perpendicular direction and do not completely contact each other so as to be easily realigned with each other to have a desired alignment state.

The controlling unit 60 aligns the upper and lower wafers W1 and W2 with each other to have a desired alignment state by recognizing an alignment state of the upper and lower wafers W1 and W2, which are observed by the microscope set, and then moving the upper wafer holder 10 connected to the holder moving unit 30 in the XYθ direction.

According to the present embodiment, the wafer aligning apparatus 100 moves the upper wafer holder 10 in, for example, the XYθ direction according to an operation of the holder moving unit 30. Alternatively, the wafer aligning apparatus 100 may, for example, pre-align the upper and lower wafers W1 and W2 with each other by moving at least one of the upper wafer holder 10 and the lower wafer holder 20.

According to an embodiment of the present invention, in a method of wafer alignment by using the wafer aligning apparatus 100, the upper wafer W1 is held by the upper wafer holder 10 and then the lower wafer W2 is seated on the lower wafer holder 20. Then, the upper wafer holder 10 attached to the holder moving unit 30 may be moved in a downward direction to pre-align the upper wafer W1 and the lower wafer W2 with each other.

Then, the microscope set accommodated in first and second microscope supports 40a and 40b may be positioned adjacent to the pre-aligned upper and lower wafers W1 and W2 in, for example, a horizontal direction with respect to the upper and lower wafers W1 and W2 and may observe edge portions of the upper and lower wafers W1 and W2. Then, observation data is transmitted to the controlling unit 60. The controlling unit 60 realigns the upper and lower wafers W1 and W2 with each other by, for example, reading the transmitted data and moving the upper wafer holder 10 connected to the holder moving unit 30 in the XYθ direction. In this case, the realigned upper and lower wafers W1 and W2 are re-observed by the microscope set. Observation data is transmitted to the controlling unit 60. Then, the controlling unit 60 may realign the upper and lower wafers W1 and W2 with each other by, for example, reading the transmitted data and moving the holder moving unit 30 in the XYθ direction. Then, the upper wafer holder 10 is moved in a downward direction such that the upper and lower wafers W1 and W2 may contact each other. Subsequent processes such as, for example, adherence or deposition are performed on the aligned upper and lower wafers W1 and W2.

According to an embodiment of the present invention, in the method of wafer alignment, the upper wafer holder 10 is moved in, for example, a downward direction toward the lower wafer holder 20 by the holder moving unit 30. Alternatively, the upper and lower wafers W1 and W2 may, for example, be pre-aligned with each other by moving the lower wafer holder 20 in an upward direction toward the upper wafer holder 10 or moving both the upper wafer holder 10 and the lower wafer holder 20 by the holder moving unit 30.

According to the present embodiment, the wafer aligning apparatus 100 realigns the upper and lower wafers W1 and W2 with each other by, for example, moving the upper wafer holder 10 in the XYθ direction according to an operation of the holder moving unit 30. Alternatively, the upper and lower wafers W1 and W2 may, for example, be realigned with each other by moving at least one of the upper wafer holder 10 and the lower wafer holder 20.

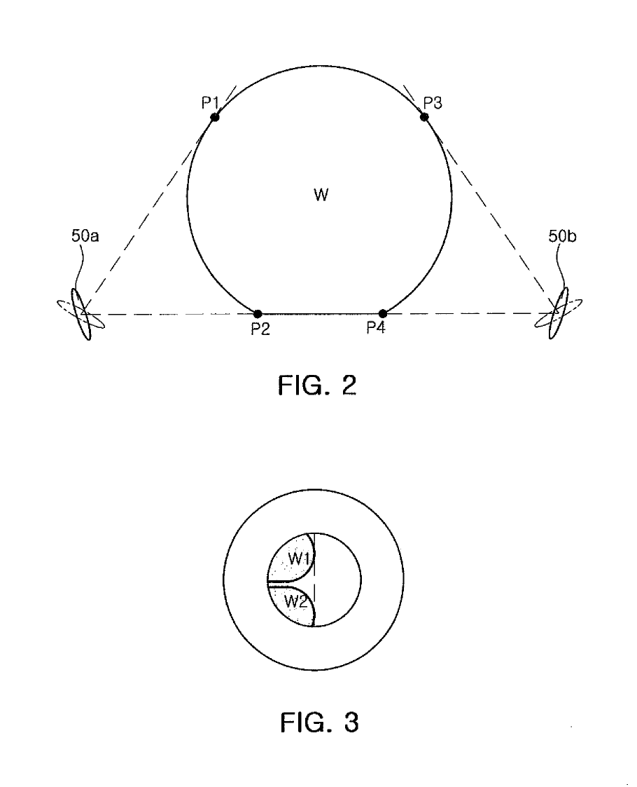

FIG. 2 is a plan view showing a method of observing the upper and lower wafers W1 and W2, which are pre-aligned with each other, via the microscopes of the wafer aligning apparatus of FIG. 1.

The microscope set of the wafer aligning apparatus 100 is used to observe edge portions of the upper and lower wafers W1 and W2 that are pre-aligned with each other. The edge portions of the upper and lower wafers W1 and W2 are observed via the first microscope 50a at observation points P1 and P2 on tangents between the first microscope 50a and the pre-aligned upper and lower wafers W1 and W2 and the edge portions of the upper and lower wafers W1 and W2 are observed via the second microscope 50b at observation points P3 and P4 on tangents between the second microscope 50b and the pre-aligned upper and lower wafers W1 and W2, such that the alignment state of the upper and lower wafers W1 and W2 is determined.

When, for example, at least three of the observation points P1, P2, P3, and P4 are aligned with each other, it may be determined whether the upper and lower wafers W1 and W2 are aligned with each other or not, so only the three points may be observed.

FIG. 3 shows the edge portions of the upper and lower wafers W1 and W2, which are observed by the microscopes of the wafer aligning apparatus of FIG. 1.

As shown in FIG. 3, when cross sections of the edge portions of the upper and lower wafers W1 and W2, observed at three of the four observation points P1, P2, P3, and P4, are positioned on a single straight line (indicated by a dotted line), it may be determined that the upper and lower wafers W1 and W2 are aligned with each other.

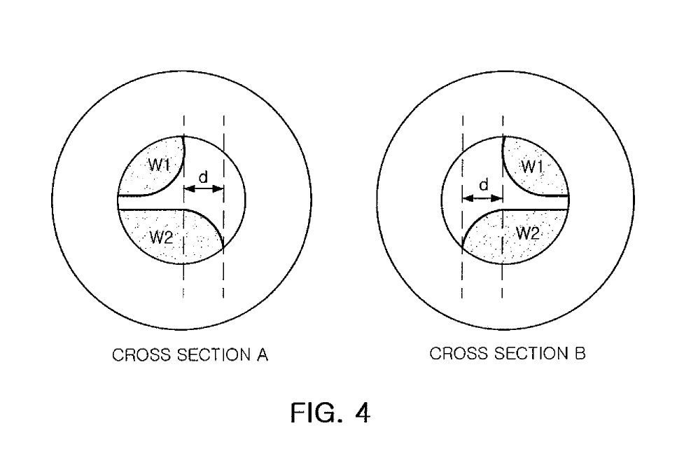

FIG. 4 shows the edge portions of the upper and lower wafers W1 and W2, which are observed by the microscopes of the Wafer aligning apparatus according to an embodiment of the present invention, when the upper and lower wafers W1 and W2 are different in terms of at least one of shape and area thereof.

As shown in FIG. 4, in a case in which the upper and lower wafers W1 and W2 are different in terms of at least one of shape and area thereof, when a first cross section A and a second cross section B of the upper and lower wafers W1 and W2, which are obtained by observing the upper and lower wafers W1 and W2 at different observation points, are the same, that is, when the upper and lower wafers W1 and W2 are equally deviated by an amount equal to ‘d’ in both the first and second cross sections, it may be determined that the upper and lower wafers W1 and W2 are aligned with each other.

In addition, as shown in FIGS. 3 and 4, when the cross sections of the upper and lower wafers W1 and W2, which are observed at three of the four observation points P1, P2, P3, and P4, correspond to each other, it may be determined that the upper and lower wafers W1 and W2 are aligned with each other.

Although two microscopes are used in the present embodiment of the present invention, it noted that exemplary embodiments of the present invention are not limited thereto. For example, alternatively, in an exemplary embodiment, a plurality of microscopes which is greater in number than two microscopes for wafer alignment may be used if necessary.

When the wafer aligning apparatus according to the present embodiment of the present invention is used to align wafers with each other, wafers having various shapes may be accurately aligned with each other and the formation of an alignment key is not required to thereby reduce manufacturing costs.

As set forth above, according to embodiments of the present invention, a method and apparatus for wafer alignment that can increase alignment accuracy via simplified processes may be provided.

According to embodiments of the present invention, the wafers may be aligned with each other, even in the case that the shapes of wafers are different.

Having described exemplary embodiments of the present invention, it is further noted that it is readily apparent to those of ordinary skill in the art that various modifications may be made without departing from the spirit and scope of the invention which is defined by the metes and bounds of the appended claims.

What is claimed is:

1. A wafer aligning apparatus, comprising:
a first wafer holder and a second wafer holder configured to support a first wafer and a second wafer, respectively;
a holder moving unit configured to move at least one of the first and second wafer holders such that the first and second wafers are pre-aligned and face each other;
one or more observing units arranged in a horizontal direction with respect to the pre-aligned first and second wafers and configured to observe edge portions of the first and second wafers in a state in which the first and second wafers are pre-aligned with each other by the holder moving unit; and
a controlling unit configured to control the holder moving unit to realign the first and second wafers when the edge portions of the first and second wafers are outside of a desired alignment state based on information observed by the one or more observing units.

2. The wafer aligning apparatus of claim 1, wherein the one or more observing units include microscopes.

3. The wafer aligning apparatus of claim 1, wherein the one or more observing units include a plurality of observing units, and
the plurality of observing units are configured to observe the edge portions in different positions.

4. The wafer aligning apparatus of claim 3, wherein the observing units are symmetrical with respect to the pre-aligned first and second wafers.

5. The wafer aligning apparatus of claim 1, wherein the one or more observing units are configured to observe observation points on tangents between the one or more observing units and outlines of the pre-aligned first and second wafers.

6. The wafer aligning apparatus of claim 1, wherein the holder moving unit controlled by the controlling unit is configured to move the first and second wafer holders in an XYθ direction.

7. The wafer aligning apparatus of claim 1, wherein the first and second wafers have a same shape and area, and
the desired alignment state is a state in which cross sections of the edge portions of the upper and lower wafers are positioned on a single straight line.

8. The wafer aligning apparatus of claim 3, wherein the first and second wafers are different in terms of at least one of shape and area thereof, and
the desired alignment state is a state in which cross sections of the edge portions of the upper and lower wafers are equally deviated at the edge portions of the upper and lower wafers observed via the plurality of observing units.

9. A method of wafer alignment, comprising:
arranging a first wafer and a second wafer on a first wafer holder and a second wafer holder, respectively;
pre-aligning the first and second wafers with each other to face each other by moving at least one of the first and second wafer holders;
observing edge portions of the first and second wafers by using one or more observing units arranged in a horizontal direction with respect to the pre-aligned first and second wafers; and
realigning the first and second wafers with each other when the edge portions of the first and second wafers observed by the one or more observing units are outside of a desired alignment state.

10. The method of claim 9, wherein the one or more observing units include microscopes.

11. The method of claim 9, wherein the one or more observing units include a plurality of observing units, and
the plurality of observing units are configured to observe the edge portions in different positions.

12. The method of claim 11, wherein the one or more observing units are provided to be symmetrical with respect to the pre-aligned first and second wafers.

13. The method of claim 9, wherein the one or more observing units are configured to observe observation points on tangents between the one or more observing units and outlines of the pre-aligned first and second wafers.

14. The method of claim 9, wherein the realigning of the first and second wafers includes moving the first and second wafer holders in an XYθ direction.

15. The method of claim 9, wherein the first and second wafers have a same shape and area, and
the desired alignment state is a state in which cross sections of the edge portions of the upper and lower wafers are positioned on a single straight line.

16. The method of claim 11, wherein the first and second wafers are different in terms of at least one of shape and area thereof, and
the desired alignment state is a state in which cross sections of the edge portions of the upper and lower wafers are equally deviated at the edge portions of the upper and lower wafers observed via the plurality of observing units.

17. The method of claim 9, wherein the first wafer is an upper wafer, the second wafer is a lower wafer, the first wafer holder is an upper wafer holder and the second wafer holder is a lower wafer holder, wherein the pre-aligning of the first and second wafers includes moving at least one of the upper wafer holder in a downward direction toward the lower wafer holder and the lower wafer holder in the upward direction toward the upper wafer holder.

18. The method of claim 17, wherein the pre-aligning of the upper and lower wafers includes moving the lower wafer holder in the upward direction toward the upper wafer holder.

19. The method of claim 17, wherein the pre-aligning of the upper and lower wafers includes moving the upper wafer holder in the downward direction toward the lower wafer holder.

20. A wafer aligning apparatus, comprising:
an upper wafer holder and a lower wafer holder configured to support an upper wafer and a lower wafer, respectively, by a force of vacuum suction;
a holder moving unit configured to move at least one of the upper wafer holder and the lower wafer holder in at least one of an upward and downward direction, respectively such that the upper and lower wafers are pre-aligned and face each other;
a plurality of microscopes accommodated in a corresponding one of a plurality of microscope supports and movable therein, wherein the microscopes are arranged in a horizontal direction with respect to the pre-aligned upper and lower wafers so as to be symmetrical with respect to the upper and lower wafers and configured to observe edge portions of the upper and lower wafers in a state in which the upper and lower wafers are pre-aligned with each other by the holder moving unit; and
a controlling unit operatively connected to the microscopes and configured to receive and read observation data from the microscopes and to control the holding moving unit to move at least one of the upper wafer holder and the lower wafer holder in an XYθ direction based upon the transmitted observation data to thereby realign the upper and lower wafers.
